(19) United States
(12) Patent Application Publication
(10) Pub. No.: US 2017/0352940 A1
(43) Pub. Date: Dec. 7, 2017

(54) INSTALLATION BRACKET

(71) Applicant: Huawei Technologies Co., Ltd., Shenzhen (CN)

(72) Inventors: Peter EKHOLM, Kista (SE); Joakim HOPPE, Kista (SE)

(21) Appl. No.: 15/687,030

(22) Filed: Aug. 25, 2017

Related U.S. Application Data
(63) Continuation of application No. PCT/EP2015/054043, filed on Feb. 26, 2015.

(51) Int. Cl. H01Q 1/12; H01Q 1/24

(52) U.S. Cl. CPC H01Q 1/1228; H01Q 1/1242; H01Q 1/246

(57) ABSTRACT

The present invention relates to an installation bracket (100), comprising a top plate unit (102) configured to be positioned at the top end of a tubular element (104), and a clamping device (106) coupled to the top plate unit (102); wherein the clamping device (106) is configured to be clamped against the inner wall (108) of the tubular element (104) thereby fixing the installation bracket (100) to the tubular element (104) in its clamping state.

### CROSS-REFERENCE TO RELATED APPLICATIONS

This application is a continuation of International Application No. PCT/EP2015/054043, filed on Feb. 26, 2015, the disclosure of which is hereby incorporated by reference in its entirety.

### TECHNICAL FIELD

The present invention relates to an installation bracket.

### BACKGROUND

When installing Telecom Equipment, such as antennas, antennas with integrated radio units or even complete radio base stations including antennas, on installation poles, the most commonly used conventional solution has been to mount the Telecom Equipment on the side of the installation pole using equipment holders attached to the outer side of the installation pole.

Another more recent conventional solution is to install the Telecom Equipment on top of a installation pole, i.e. “top of pole installation of Telecom Equipment”, by that a part of a holder unit for the Telecom Equipment unit is inserted from above around the outside of the installation pole or into an upwards open cavity at the top end of the installation pole, several holes are drilled through this part of the holder unit and the therein or therearound situated part of the installation pole, whereafter several locking screws are inserted in the respective holes thus locking the Telecom Equipment to the installation pole.

The problem with the above conventional solutions for “top of pole installation of Telecom Equipment” is that for each specific installation pole with a specific shape and specific dimensions, an equipment holder unit with the corresponding specific shape and dimensions has to be manufactured.

### SUMMARY

An objective of embodiments of the present invention is to provide a solution which solves the drawbacks and problems of conventional solutions.

The above objectives are solved by the subject matter of the independent claim. Further advantageous implementation forms of the present invention can be found in the dependent claims.

According to a first aspect of the invention, the above mentioned and other objectives are achieved with an installation bracket, comprising:

a top plate unit configured to be positioned at the top end of a tubular element, and

a clamping device coupled to the top plate unit;

wherein the clamping device is configured to be clamped against the inner wall of the tubular element thereby fixing the installation bracket to the tubular element in its clamping state.

A tubular element in this disclosure should be understood as a hollow elongated element having e.g. a cylindrical, oval, rectangular or polygonal cross-section shape, and where the cross-section dimension is substantially equal along or alters along the tubular element, i.e. e.g. a cylindrical or conical tube used as a installation pole or installation tower for e.g. telecom equipment for e.g. a wireless communication system.

Examples of telecom equipment configured to be mounted on the tubular element are e.g. antennas, antennas with integrated radio units, and complete radio base stations including antennas.

Further, the expression “clamping state” in this disclosure should be understood as a state in which the clamping device is clamped against the inner wall of the tubular element.

An advantage with this first aspect is that it is possible to provide a solution which supports use of the one and the same installation bracket, comprising a clamping device, for different tubular elements having different inner and outer diameters and shapes, i.e. a use on a wide range of inner and outer diameter dimensions for tubular elements. Therefore, there is no need to manufacture a separate installation bracket with the corresponding specific shape and dimensions of each specific tubular element.

Further advantages with this first aspect are that no holes have to be drilled in the tubular element on the installation site or have to be prefabricated into the tubular element before installation, no externally visible fixing bolts are needed thus supporting flush appearance between the tubular element and the equipment configured to be mounted on the installation bracket, azimuth adjustment of telecom equipment configured to be mounted on the tubular element is supported during installation and maintenance of the installation bracket, and self locating secure mounting of the installation bracket to the tubular element is supported both on vertical and inclined tubular elements.

In a first possible implementation form of an installation bracket according to the first aspect, the installation bracket further comprises a locating arrangement coupled to the top plate unit, wherein the locating arrangement is configured to position the top plate unit in or on the tubular element.

An advantage with this implementation form is that it is possible to position the top plate unit in or on different tubular elements having different inner and outer diameters and shapes. Therefore, there is no need to manufacture a separate top plate unit with the corresponding specific shape and dimensions of each specific tubular element.

In a second possible implementation form of an installation bracket according to the first implementation form of the first aspect, the locating arrangement comprises at least three locating devices configured to position the top plate unit in or on the tubular element.

An advantage with this implementation form is that it is possible to position the top plate unit at a preferred position in tubular elements having different inner and outer shapes.

In a third possible implementation form of an installation bracket according to the second implementation form of the first aspect, the at least three locating devices are configured to be releasably locked to the top plate unit, and further configured to position the top plate unit in or on the tubular element when abutting against the inner wall of the tubular element in the locked state of the respective locating device.

An advantage with this implementation form is that it is possible to unlock the locating devices if necessary e.g. during maintenance.

In a fourth possible implementation form of an installation bracket according to the third implementation form of the first aspect, the respective locating device is in its unlocked state configured to be displaceable in a respective slot in the top plate unit towards and away from the inner wall of the tubular element.

An advantage with this implementation form is that it is possible to adjust the position of the respective locating device without completely removing it from the top plate unit.

In a fifth possible implementation form of an installation bracket according to any of the above implementation forms of the first aspect or the first aspect as such, the clamping device comprises at least three clamping units configured to abut against the inner wall of the tubular element in the clamping state of the clamping device.

An advantage with this implementation form is that it is possible to use of the one and the same clamping device for different tubular elements having different inner and outer diameters and shapes. Therefore, there is no need to manufacture a separate clamping device with the corresponding specific shape and dimensions of each specific tubular element.

In a sixth possible implementation form of an installation bracket according to the fifth implementation form of the first aspect, the installation bracket further comprises a clamping actuator mechanism, wherein the clamping units are configured to be displaceable towards and away from the inner wall of the tubular element by operation of the clamping actuator mechanism.

An advantage with this implementation form is that it is possible to remotely adjust the position of the clamping units.

In a seventh possible implementation form of an installation bracket according to the sixth implementation form of the first aspect, the clamping actuator mechanism comprises a clamping actuator screw configured to control the movement of the clamping units towards and away from the inner wall of the tubular element.

An advantage with this implementation form is that it is possible to control the movement of the clamping units in a continuously variable way, and thus use of the one and the same installation bracket for different tubular elements having different inner and outer diameters and shapes. Therefore, there is no need to manufacture a separate installation bracket with the corresponding specific shape and dimensions of each specific tubular element.

In an eighth possible implementation form of an installation bracket according to the seventh implementation form of the first aspect, a thread arranged on the clamping actuator screw is configured to pass through, and interact with a corresponding thread in, a threaded hole in the top plate unit.

An advantage with this implementation form is that it is possible to control the movement of the clamping units in a continuously variable way from the outside of the tubular element.

In a ninth possible implementation form of an installation bracket according to the seventh or eighth implementation form of the first aspect, the clamping actuator mechanism further comprises a clamping unit retainer device and a clamping unit guide device, where the respective clamping unit is pivotally mounted on the clamping unit retainer device, where the clamping unit retainer device is configured to move axially together with the clamping actuator screw when the clamping actuator screw is turned around its axis, and where the clamping unit guide device is immovably fixed to the top plate unit.

An advantage with this implementation form is that it is possible to control the movement of the clamping units in a well defined continuously variable way.

In a tenth possible implementation form of an installation bracket according to the ninth implementation form of the first aspect, the clamping unit guide device has a corresponding slot for each clamping unit, where each slot is closed at the end opposite to the position of the top plate unit, where each clamping unit is configured to abut against the clamping unit guide device at the respective closed end of the respective corresponding slot during operation of the clamping actuator screw, where each slot is configured to run in parallel with the axis of the clamping actuator screw, and where the walls of each slot are configured to control the movement of the respective clamping unit along the axis of the clamping actuator screw when the clamping actuator screw is turned around its axis.

An advantage with this implementation form is that it is possible to control the movement of the clamping units in well defined directions.

In an eleventh possible implementation form of an installation bracket according to the ninth or tenth implementation form of the first aspect, the clamping unit guide device is configured to be immovably fixed to the top plate unit by that a clamping screw sleeve is immovably fixed at one end to the top plate unit and immovably fixed at the other end to the clamping unit guide device.

An advantage with this implementation form is that it is possible to control the movement of the clamping units without the risk for internal angular displacements within the installation bracket.

In a twelfth possible implementation form of an installation bracket according to the eleventh implementation form of the first aspect, the clamping actuator screw is configured positioned within the clamping screw sleeve.

An advantage with this implementation form is that the surface of the clamping actuator screw is protected by the clamping screw sleeve.

In a thirteenth possible implementation form of an installation bracket according to any of the above seventh to twelfth implementation forms of the first aspect, the clamping actuator screw is configured to be locked to the top plate unit by a locking nut in the clamping state of the clamping device.

An advantage with this implementation form is that unwanted release of the installation bracket from the tubular element is avoided.

In a fourteenth possible implementation form of an installation bracket according to any of the above ninth to thirteenth implementation forms of the first aspect, the respective clamping unit comprises a clamping leg pivotally coupled to the clamping unit retainer device, and further comprises a clamping foot pivotally coupled to the clamping leg, wherein the clamping foot is configured to provide an axially extended contact at the inner wall of the tubular element in the clamping state of the clamping device.

An advantage with this implementation form is that the contact between the respective clamping unit and the inner wall of the tubular element can be distributed over a more widespread area.

Further applications and advantages of the present invention will be apparent from the following detailed description.

### BRIEF DESCRIPTION OF THE DRAWINGS

The appended drawings are intended to clarify and explain different embodiments of the present invention, in which:

FIG. 1 shows an installation bracket according an embodiment of the present invention;

FIG. 2 shows a partly sectioned view of the installation bracket according to FIG. 1;

FIG. 3 shows a side view of the installation bracket 100 according to FIG. 1;

FIG. 4 shows a side view of a tubular element and a thereon mounted piece of Telecom Equipment;

FIG. 5 shows a side view of a further tubular element and a thereon mounted piece of Telecom Equipment;

FIG. 6 shows a sectioned top view of an installation bracket according to FIG. 1;

FIG. 7 shows another sectioned top view of an installation bracket according to FIG. 1; and

FIG. 8 shows a further sectioned top view of a installation bracket according to FIG. 1.

### DETAILED DESCRIPTION

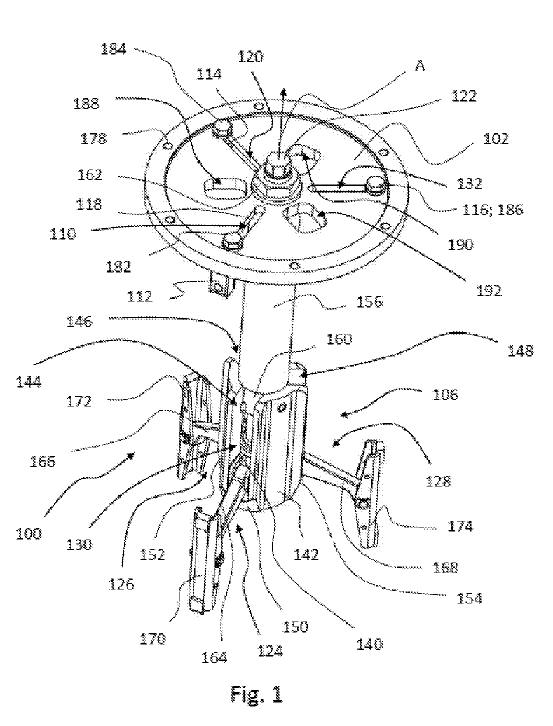

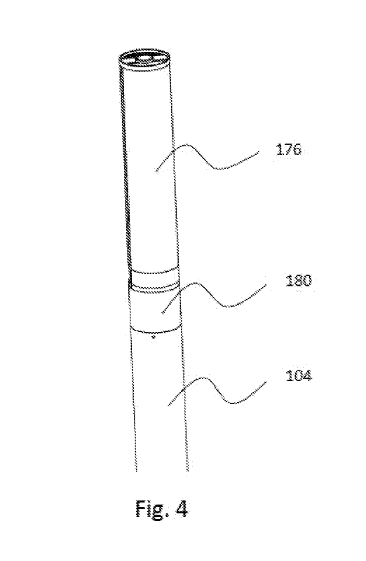

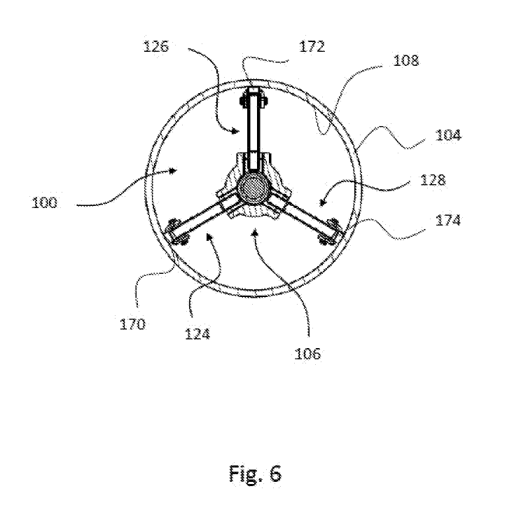

FIG. 1 shows an installation bracket 100 according an embodiment of the present invention, the installation bracket 100 comprising a top plate unit 102 configured to be positioned at the top end of a tubular element (104—see FIGS. 4 to 8), and a clamping device 106 coupled to the top plate unit 102, wherein the clamping device 106 is configured to be clamped against the inner wall (108—see FIGS. 6 to 8) of the tubular element thereby fixing the installation bracket 100 to the tubular element in its clamping state.

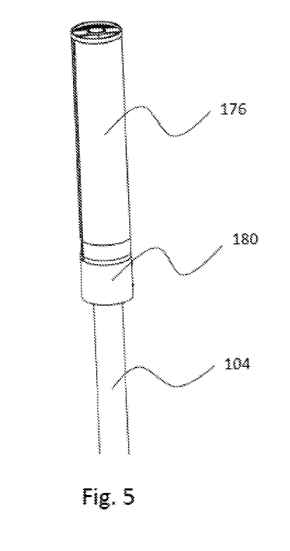

According to one embodiment, the tubular element can be an installation pole or installation tower for equipment (176—see FIGS. 4 and 5).

According to one embodiment, the equipment (176—see FIGS. 4 and 5) configured to be mounted on the installation bracket 100 can be telecom equipment, e.g. an antenna, an antenna with integrated radio units, or a complete radio base station including at least one antenna.

The equipment configured to be mounted on the installation bracket 100 can be mounted directly thereon, or indirectly thereon via an intermediate spacer element, by e.g. using mounting holes 178 in the installation bracket 100. If cables to the equipment configured to be mounted on the installation bracket 100 are to be routed inside the tubular element, the spacer element can be designed to distance the equipment from the tubular element in order to allow for cable attachment after mounting of the installation bracket 100 to the tubular element and the equipment to the installation bracket 100. After attachment of the cables, this void between the tubular element and the equipment can thereafter be covered by a sleeve unit (180—see FIGS. 4 and 5).

According to an embodiment of the invention, the installation bracket 100 can further comprise a locating arrangement 110 coupled to the top plate unit 102, wherein the locating arrangement 110 is configured to position the top plate unit 102 in or on the tubular element.

According to an embodiment of the invention, the locating arrangement 110 can comprise at least three locating devices 112, 114, 116 configured to position the top plate unit 102 in or on the tubular element.

According to an embodiment of the invention, the at least three locating devices 112, 114, 116 are configured to be releasably locked to the top plate unit 102 and further configured to position the top plate unit 102 in or on the tubular element when abutting against the inner wall of the tubular element in the locked state of the respective locating device 112, 114, 116.

According to an embodiment of the invention, the respective locating device 112, 114, 116 is in its unlocked state configured to be displaceable in a respective slot 118, 120, 122 in the top plate unit 102 towards and away from the inner wall of the tubular element.

According to an embodiment of the invention, the respective locating device 112, 114, 116 may comprise a respective locking screw 182, 184, 186 with which the respective locating device 112, 114, 116 can be locked in position in the respective slot 118, 120, 122 in the top plate unit 102.

According to an embodiment of the invention, the clamping device 106 comprises at least three clamping units 124, 126, 128 configured to abut against the inner wall of the tubular element in the clamping state of the clamping device.

According to an embodiment of the invention, the installation bracket 100 further comprises a clamping actuator mechanism 130, wherein the clamping units 124, 126, 128 are configured to be displaceable towards and away from the inner wall of the tubular element by operation of the clamping actuator mechanism 130.

According to an embodiment of the invention, the clamping actuator mechanism 130 comprises a clamping actuator screw 132 configured to control the movement of the clamping units 124, 126, 128 towards and away from the inner wall of the tubular element.

According to an embodiment of the invention, the clamping actuator mechanism 130 further comprises a clamping unit retainer device 140 and a clamping unit guide device 142, where the respective clamping unit 124, 126, 128 is pivotally mounted on the clamping unit retainer device 140, where the clamping unit retainer device 140 is configured to move axially together with the clamping actuator screw 132 when the clamping actuator screw 132 is turned around its axis A, and where the clamping unit guide device 142 is immovably fixed to the top plate unit 102.

According to an embodiment of the invention, the clamping unit guide device 142 has a corresponding slot 144, 146, 148 for each clamping unit 124, 126, 128, where each slot 144, 146, 148 is closed at the end 150, 152, 154 opposite to the position of the top plate unit 102, where each clamping unit 124, 126, 128 is configured to abut against the clamping unit guide device 142 at the respective closed end 150, 152, 154 of the respective corresponding slot 144, 146, 148 during operation of the clamping actuator screw 132, where each slot 144, 146, 148 is configured to run in parallel with the axis A of the clamping actuator screw 132, and where the walls of each slot 144, 146, 148 are configured to control the movement of the respective clamping unit 124, 126, 128 along the axis A of the clamping actuator screw 132 when the clamping actuator screw 132 is turned around its axis A.

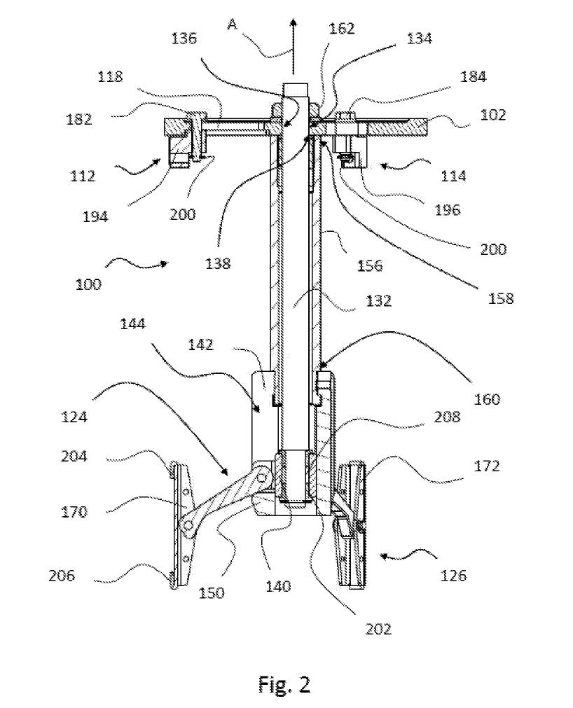

According to an embodiment of the invention, the clamping unit guide device 142 is configured to be immovably fixed to the top plate unit 102 by that a clamping screw sleeve 156 is immovably fixed at one end (158—see FIG. 2) to the top plate unit 102 and immovably fixed at the other end 160 to the clamping unit guide device 142. This can be done using at least one threaded joint or at least one welded joint or at least one bayonet mount with a locking screw or by integrating the clamping screw sleeve 156 with the top plate unit 102 or the clamping unit guide device 142.

According to an embodiment of the invention, the clamping actuator screw 132 is configured positioned within the clamping screw sleeve 156.

According to an embodiment of the invention, the clamping actuator screw 132 is configured to be locked to the top plate unit 102 by a locking nut 162 in the clamping state of the clamping device 106.

According to an embodiment of the invention, the respective clamping unit 124, 126, 128 comprises a clamping leg 164, 166, 168 pivotally coupled to the clamping unit retainer device 140, and further comprises a clamping foot 170, 172, 174 pivotally coupled to the clamping leg 164, 166, 168, wherein the clamping foot 170, 172, 174 is configured to provide an axially extended contact at the inner wall of the tubular element in the clamping state of the clamping device 106.

Cables to the equipment configured to be mounted on the installation bracket can be routed outside of the tubular element, but openings 188, 190, 192 in the top plate unit 102 also support cable routing inside the tubular element.

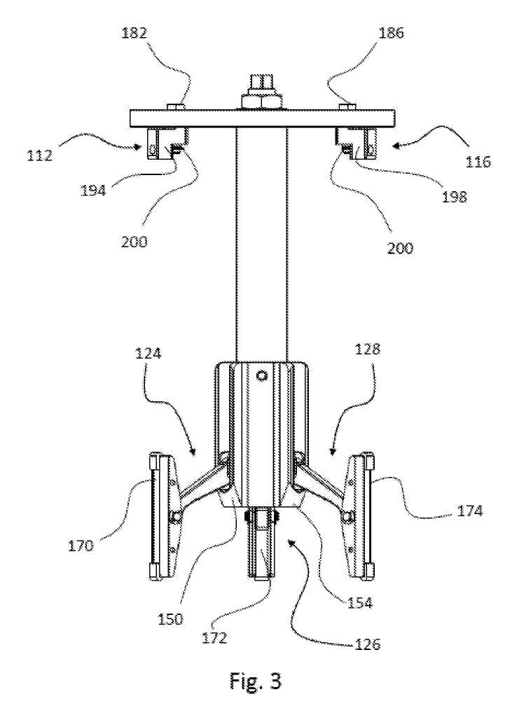

FIG. 2 shows a partly sectioned view of the installation bracket 100 according to FIG. 1, and FIG. 3 shows a side view of the installation bracket 100 according to FIG. 1.

Referring now to FIGS. 2 and 3:

According to an embodiment of the invention, a thread 134 arranged on the clamping actuator screw 132 is configured to pass through, and interact with a corresponding thread 136 in, a threaded hole 138 in the top plate unit 102, as can be seen in the figure. Thus, when the clamping actuator screw 132 of the clamping actuator mechanism 130 is turned around its axis A, the clamping actuator screw 132 moves up and down through the threaded hole 138 in the top plate unit 102.

The operation of the clamping units 124, 126, 128 (for 128—see FIG. 3) is now described referring to the parts of clamping unit 124 shown in the figure, where the other two clamping units 126, 128 are operated in the same way.

As mentioned above, the clamping unit guide device 142 is immovably fixed to the top plate unit 102, e.g. by that a clamping screw sleeve 156 is immovably fixed at one end 158 to the top plate unit 102 and immovably fixed at the other end 160 to the clamping unit guide device 142, whereas the clamping unit retainer device 140 is configured to move axially together with the clamping actuator screw 132 when the clamping actuator screw 132 is turned around its axis A. The clamping unit retainer device 140 is configured to be able to turn around the axis of the clamping actuator screw 132 in relation to the clamping actuator screw 132. This can be accomplished by mounting the clamping unit retainer device 140 in a radial groove 208 on the clamping actuator screw 132.

Thus, when the clamping actuator screw 132 moves up and down, the clamping unit retainer device 140 moves up and down together with the clamping actuator screw 132. As the respective clamping unit 124, 126, 128 is pivotally mounted on the clamping unit retainer device 140, the clamping unit guide device 142 is immovably fixed to the top plate unit 102, and as each clamping unit 124, 126, 128 is configured to abut against the clamping unit guide device 142 at the respective closed end 150, 152, 154 (for 152 and 154—see FIG. 1) of the respective corresponding slot 144, 146, 148 (for 146 and 148—see FIG. 1) during operation of the clamping actuator screw 132, a downward movement of the clamping actuator screw 132 and thus the clamping unit retainer device 140 results in an upward and outward movement of each clamping unit 124, 126, 128. When the clamping screw 132 is moved upwards, each clamping unit 124, 126, 128 moves downwards and inwards. Thus, the movement of the clamping units 124, 126, 128 towards and away from the inner wall of the tubular element is controlled by turning the clamping actuator screw 132 around its axis A.

In the figure is also shown an embodiment of the locating arrangement 110 comprising three locating devices 112, 114, 116 (for 116—see FIG. 3) configured to position the top plate unit 102 in the tubular element. According to this embodiment, the respective locating device 112, 114, 116 is in its unlocked state configured to be displaceable in a respective slot 118, 120, 122 in the top plate unit 102 towards and away from the inner wall of the tubular element, where the respective locating device 112, 114, 116 in this embodiment comprise a respective locking screw with which the respective locating device 112, 114, 116 can be locked in position in the respective slot 118, 120, 122 (for 120 and 122 —see FIG. 1) in the top plate unit 102. As can be seen in the figure, the respective slot 118, 120, 122 can be a stepped slot. When using a stepped slot, only one locking screw is needed for the locating member 194, 196, 198 of each locating device 112, 114, 116.

A circlip 200 can be arranged at the end of the respective locking screw 182, 184, 186 in order to avoid that the locating member 194, 196, 198 of the respective locating device 112, 114, 116 is separated from the top plate unit 102 when the locking screw 182, 184, 186 is opened.

A bushing 202 made of a material with low friction can be arranged between the clamping actuator screw 132 and the clamping unit retainer device 140 in order to decrease friction therebetween during operation of the clamping actuator mechanism 130.

According to one embodiment, the respective clamping foot 170, 172, 174 is configured to provide an axially extended contact at the inner wall of the tubular element in the clamping state of the clamping device 106 by configuring the respective clamping foot 170, 172, 174 with axially displaced contact members, 204, 206.

FIG. 4 shows a side view of a tubular element 104, e.g. an installation pole for telecom equipment, and a thereon mounted piece of equipment 176, e.g. telecom equipment, where the outer diameter of the tubular element 104 is similar to that of the thereon mounted piece of equipment 176. A sleeve unit 180 covering a void between the tubular element 104 and the equipment 176 is also shown in the figure.

FIG. 5 shows a side view of a tubular element 104, e.g. an installation pole for telecom equipment, and a thereon mounted piece of equipment 176, e.g. telecom equipment, where the outer diameter of the tubular element 104 is smaller than that of the thereon mounted piece of equipment 176. A sleeve unit 180 covering a void between the tubular element 104 and the equipment 176 is also shown in the figure.

FIG. 6 shows a sectioned top view of a installation bracket 100 according to FIG. 1, which is mounted on top of a tubular element 104 having a circular cross-section. In the figure is shown an embodiment of the invention, where the clamping device 106 comprises at least three clamping units 124, 126, 128 configured to abut against the inner wall 108 of the tubular element 104 in the clamping state of the clamping device 106.

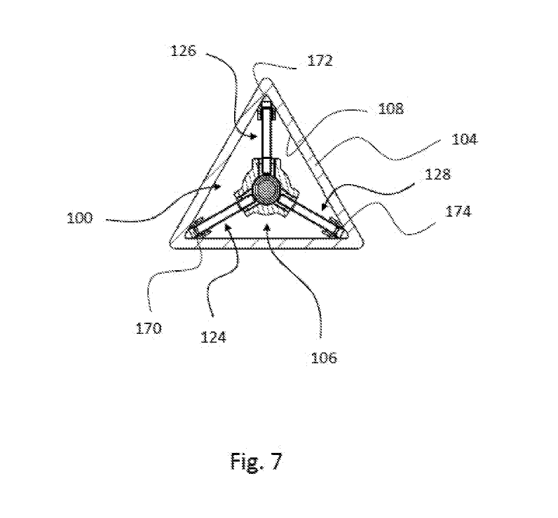

FIG. 7 shows another sectioned top view of a installation bracket 100 according to FIG. 1, which is mounted on top of a tubular element 104 having a triangular cross-section. In the figure is shown an embodiment of the invention, where the clamping device 106 comprises at least three clamping units 124, 126, 128 configured to abut against the inner wall 108 of the tubular element 104 in the clamping state of the clamping device 106.

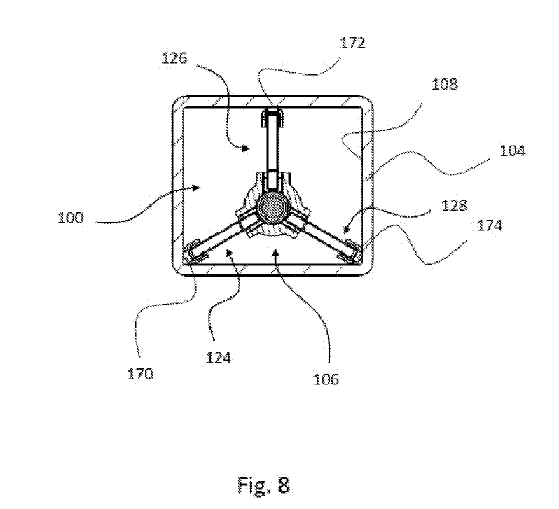

FIG. 8 shows a further sectioned top view of a installation bracket 100 according to FIG. 1, which is mounted on top of a tubular element 104 having a rectangular cross-section. In the figure is shown an embodiment of the invention, where the clamping device 106 comprises at least three clamping units 124, 126, 128 configured to abut against the inner wall 108 of the tubular element 104 in the clamping state of the clamping device 106.

The tubular element can also have other non-circular cross-section shapes than those shown in FIGS. 7 and 8, e.g. hexagonal and octagonal, etc. In order to adjust the installation bracket more closely to tubular element cross-section shapes other than the circular shape, it is possible but not necessary to modify the number of clamping units, the number of locating devices, the top plate unit shape, the shape of the clamping unit retainer device, and the shape of the clamping unit guide device.

Reference is now made to FIG. 1-8.

The installation bracket 100 according to the embodiment shown in the FIGS. 1-8 is mounted on a tubular element 104 as follows:

Firstly, the clamping device 106 of the installation bracket 100 is inserted into the tubular element 104 until the top plate unit 102 of the installation bracket 100 is positioned at the top end of the tubular element 104, i.e. until a part of the top plate unit 102 rests on the upper edge of the tubular element 104.

Thereafter, the clamping device 106 is clamped against the inner wall 108 of the tubular element 104 thereby fixing the installation bracket 100 to the tubular element 104 in its clamping state, i.e. the clamping actuator screw 132 is turned about its axis A, i.e. “tightened”, until the respective clamping unit 124, 126, 128, i.e. the respective clamping foot 170, 172, 174, abuts against the inner wall 108 of the tubular element 104. The installation bracket 100 does therefore not need to be correctly positioned in the tubular element 104 before clamping, but is instead self-locating in the tubular element 100.

Due to the movement of the respective clamping unit 124, 126, 128, the top plate unit 102 is drawn towards the tubular element 104 during the final part of the “tightening” of the clamping actuator screw 132 as the respective clamping unit 124, 126, 128 has reached the inner wall 108 of the tubular element 104. Thus a water tight joint can be achieved between the top plate unit 102 and the tubular element 104 if the tubular element 104 or the top plate unit 102 comprises a gasket arranged thereon at the at the joint therebetween.

When the clamping device 106 has been clamped against the inner wall 108 of the tubular element 104, the clamping actuator screw 132 can be locked to the top plate unit 102 by a locking nut 162 in the clamping state of the clamping device 106 in order to avoid unwanted movement of the clamping actuator screw 132 and thus the respective clamping foot 170, 172, 174.

The equipment 176 configured to be mounted on the installation bracket 100 and thus on the tubular element 104 can be mounted on the installation bracket 100 before or after the installation bracket 100 is mounted on the tubular element 104.

If the equipment 176 configured to be mounted on the installation bracket 100 comprises an antenna, it is preferred to adjust the antenna azimuth angle by turning the installation bracket 100 about its axis before the clamping device 106 is clamped against the inner wall 108 of the tubular element 104.

If the installation bracket 100 comprises a locating arrangement 110 comprising at least three locating devices 112, 114, 116 configured to position the top plate unit 102 in the tubular element 104, the locating devices 112, 114, 116 can be made to abut against the inner wall 108 of the tubular element 104 before or after the clamping device 106 is clamped against the inner wall 108 of the tubular element 104.

Finally, it should be understood that the present invention is not limited to the embodiments described above, but also relates to and incorporates all embodiments within the scope of the appended independent claims.

What is claimed is:

1. Installation bracket (100), comprising:
a top plate unit (102) configured to be positioned at the top end of a tubular element (104), and
a clamping device (106) coupled to the top plate unit (102);
wherein the clamping device (106) is configured to be clamped against the inner wall (108) of the tubular element (104) thereby fixing the installation bracket (100) to the tubular element (104) in its clamping state.

2. The installation bracket (100) according to claim 1, further comprising a locating arrangement (110) coupled to the top plate unit (102), wherein the locating arrangement (110) is configured to position the top plate unit (102) in or on the tubular element (104).

3. The installation bracket (100) according to claim 2, wherein the locating arrangement (110) comprises at least three locating devices (112, 114, 116) configured to position the top plate unit (102) in or on the tubular element (104).

4. The installation bracket (100) according to claim 3, wherein the at least three locating devices (112, 114, 116) are configured to be releasably locked to the top plate unit (102), and further configured to position the top plate unit (102) in or on the tubular element (104) when abutting against the inner wall (108) of the tubular element (104) in the locked state of the respective locating device (112, 114, 116).

5. The installation bracket (100) according to claim 4, wherein the respective locating device (112, 114, 116) in its unlocked state is configured to be displaceable in a respective slot (118, 120, 122) in the top plate unit (102) towards and away from the inner wall (108) of the tubular element (104).

6. The installation bracket (100) according to claim 1, wherein the clamping device (106) comprises at least three clamping units (124, 126, 128) configured to abut against the inner wall (108) of the tubular element (104) in the clamping state of the clamping device (106).

7. The installation bracket (100) according to claim 6, further comprising a clamping actuator mechanism (130), wherein the clamping units (124, 126, 128) are configured to be displaceable towards and away from the inner wall (108) of the tubular element (104) by operation of the clamping actuator mechanism (130).

8. The installation bracket (100) according to claim 7, wherein the clamping actuator mechanism (130) comprises a clamping actuator screw (132) configured to control the movement of the clamping units (124, 126, 128) towards and away from the inner wall (108) of the tubular element (104).

9. The installation bracket (100) according to claim 8, wherein a thread (134) arranged on the clamping actuator screw (132) is configured to pass through, and interact with a corresponding thread (136) in, a threaded hole (138) in the top plate unit (102).

10. The installation bracket (100) according to claim 8, wherein the clamping actuator mechanism (130) further comprises a clamping unit retainer device (140) and a clamping unit guide device (142), where the respective clamping unit (124, 126, 128) is pivotally mounted on the clamping unit retainer device (140), where the clamping unit retainer device (140) is configured to move axially together with the clamping actuator screw (132) when the clamping actuator screw (132) is turned around its axis (A), and where the clamping unit guide device (142) is immovably fixed to the top plate unit (102).

11. The installation bracket (100) according to claim 10, wherein the clamping unit guide device (142) has a corresponding slot (144, 146, 148) for each clamping unit (124, 126, 128), where each slot (144, 146, 148) is closed at the end (150, 152, 154) opposite to the position of the top plate unit (102), where each clamping unit (124, 126, 128) is configured to abut against the clamping unit guide device (142) at the respective closed end (150, 152, 154) of the respective corresponding slot (144, 146, 148) during operation of the clamping actuator screw (132), where each slot (144, 146, 148) is configured to run in parallel with the axis (A) of the clamping actuator screw (132), and where the walls of each slot (144, 146, 148) are configured to control the movement of the respective clamping unit (124, 126, 128) along the axis (A) of the clamping actuator screw (132) when the clamping actuator screw (132) is turned around its axis (A).

12. The installation bracket (100) according to claim 10, wherein the clamping unit guide device (142) is configured to be immovably fixed to the top plate unit (102) by that a clamping screw sleeve (156) is immovably fixed at one end (158) to the top plate unit (102) and immovably fixed at the other end (160) to the clamping unit guide device (142).

13. The installation bracket (100) according to claim 12, wherein the clamping actuator screw (132) is configured positioned within the clamping screw sleeve (156).

14. The installation bracket (100) according to claim 8, wherein the clamping actuator screw (132) is configured to be locked to the top plate unit (102) by a locking nut (162) in the clamping state of the clamping device (106).

15. The installation bracket (100) according to claim 10, wherein the respective clamping unit (124, 126, 128) comprises a clamping leg (164, 166, 168) pivotally coupled to the clamping unit retainer device (140), and further comprises a clamping foot (170, 172, 174) pivotally coupled to the clamping leg (164, 166, 168), wherein the clamping foot (170, 172, 174) is configured to provide an axially extended contact at the inner wall (108) of the tubular element (104) in the clamping state of the clamping device (106).
